(19) United States
(12) Patent Application Publication
(10) Pub. No.: US 2021/0099228 A1
(43) Pub. Date: Apr. 1, 2021

(54) UNDERWATER FREE SPACE OPTICAL COMMUNICATION SYSTEMS

(71) Applicant: THE REGENTS OF THE UNIVERSITY OF CALIFORNIA, Oakland, CA (US)

(72) Inventors: Mohammad-Reza Alam, Orinda, CA (US); Alexandre Immas, Oakland, CA (US); Mohsen Saadat, Minneapolis, MN (US)

(73) Assignee: THE REGENTS OF THE UNIVERSITY OF CALIFORNIA, Oakland, CA (US)

(21) Appl. No.: 17/070,679

(22) Filed: Oct. 14, 2020

Related U.S. Application Data
(63) Continuation of application No. PCT/US2019/027697, filed on Apr. 16, 2019.
(60) Provisional application No. 62/658,577, filed on Apr. 16, 2018.

(51) Int. Cl. H04B 10/112; H04B 13/02; B63G 8/00

(52) U.S. Cl. CPC H04B 10/1129; H04B 13/02; B63G 2008/004; B63B 2203/00; B63G 8/001

(57) ABSTRACT

Systems and methods for high bandwidth optical communications using a swarm of optically linked autonomous underwater vehicles and support vehicles that allow communications over long-distances between two points and over a wide area. At least one of the linked autonomous underwater vehicles transmit the optical communications to a control station and can receive control communications from the station. Communication pathways and networks between vehicles in the swarm are dynamic and may be redundant.

### CROSS-REFERENCE TO RELATED APPLICATIONS

This application claims priority to, and is a 35 U.S.C. § 111(a) continuation of, PCT international application number PCT/US2019/027697 filed on Apr. 16, 2019, incorporated herein by reference in its entirety, which claims priority to, and the benefit of, U.S. provisional patent application Ser. No. 62/658,577 filed on Apr. 16, 2018, incorporated herein by reference in its entirety. Priority is claimed to each of the foregoing applications.

The above-referenced PCT international application was published as PCT International Publication No. WO 2019/204319 on Oct. 24, 2019, which publication is incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to devices and methods for wireless communications, and more particularly to systems and methods for high bandwidth optical underwater communications using a coordinated swarm of mobile autonomous underwater vehicles with optical transmitters and receivers that can relay optical signals over long distances or areas.

### 2. Background Discussion

Current approaches to exploration of the sea floor typically first use surface boats equipped with sonar to take rough pictures of the sea bed. Once an area of interest is identified, Remotely Operated Vehicles (ROVs) or manned underwater vehicles are sent to explore the area in more detail. ROVs are connected with a cable to a support vessel limiting their area of exploration and the number of vehicles that can be operated at the same time. Autonomous Underwater Vehicles (AUVs) have so far offered a poor alternative because of the impossibility of communicating with them during operation. Current technology is not capable of fast and efficient underwater exploration because of the limited ability to communicate.

Underwater communication between submersibles or surface vessels is limited without a physical connection through a tether. Although a tether may allow high bandwidth transmissions, the system does not allow transmissions over long distances or wide areas because of the practical limitations in the length of the tether. It is also difficult to operate multiple vehicles in an area at the same time because of the possibility that the tethers of the vehicles will become tangled.

Wireless underwater communication presents many challenges and current approaches are not able to transmit data with large bandwidth and over long distance and/or over a wide area. While Radio Frequencies (RF) have allowed an extensive development of wireless communication in air, water absorption, scattering and turbidity prevent radio waves from being used in water. Radio Frequencies (RF) in water have a range that is limited to less than a few meters because of the high permittivity and electrical conductivity of sea water.

Acoustic transmission has therefore been the standard technology for decades, but such transmissions suffer from a very small bandwidth. Sound waves are limited to a very low bandwidth of only 10-100 Kbps and therefore is incapable of dealing with a video stream or conventional large data stream which requires a bandwidth higher than 10 Mbps.

The use of tethers is therefore the only solution for sending data with high bandwidth and over long distance as acoustic waves suffer from a low bandwidth of tens of Kbps and are thus only suitable for basic communications. Accordingly, new technologies enabling high bandwidth underwater wireless communications over long-distances and depths are needed.

### BRIEF SUMMARY

Underwater wireless data communication is the most important outstanding problem in ocean exploration, impeding nearly all major research expeditions and many industrial developments. The present technology provides a new system and method for long-distance and/or wide-area underwater free space optical communication. High-bandwidth underwater wireless communication can be achieved over long-distances using a swarm of Autonomous Underwater Vehicles (AUVs) relaying an optical signal. In one embodiment, the method uses a swarm of Super-Agile Autonomous Underwater Vehicles (AUVs), a control station and a deck station. In one embodiment, each of the AUVs includes a mechanical system, a controller, a receiver, a transmitter, and a position sensor such a camera or a sonar. The deck station includes a supporting structure and parking lots for the AUVs. The control station includes fixed receivers attached to the deck's supporting structure and linked to a monitoring and surveillance system.

The mechanical system accurately controls the orientation and position of the individual AUV's. The position sensors provide information on the surroundings including the presence of other AUVs in the swarm. The controller processes the data provided by the position sensor and provides inputs to the mechanical system in order to align the transmitter of the AUV to the receiver of another AUV. The transmitter and receiver are parts of a Free Space Optical system (e.g., laser, LED) allowing high bandwidth communication.

The high stability and agility of the AUV allows the vehicle to maintain a correct alignment between the receiver and the transmitter of two different AUVs keeping the data communication operational. In the case that communication is lost, the AUV uses data provided by the position sensor to restore the connection. The swarm configuration allows the system to communicate over a long-distance between two points and over a wide area.

The AUVs of the coordinated swarm will be lined up at distances less than the maximum range of the laser. Then, each AUV will receive the signal from the one below, amplify the signal and send it to the next one on the top until the signal reaches the station on the surface where it can be easily communicated with a satellite, for example. Blue light (600 THz or 475 nm) has the minimum absorption in water, and therefore has the longest range in water and is the most suited for the application. However, communication at high frequencies requires very accurate pointing precision. For this purpose, a super-agile re-orientation system based on the Control Moment Gyro concept is installed on each AUV in one embodiment. By applying torque on the inside gyro, AUV can reorient itself without the need for any external actuator (i.e. thrusters). Therefore, reorientation maneuvers are energy-efficient and can be very fast, hence resulting in a superagile AUV (AUV).

Fast orientation and reorientation maneuvers help to keep the communication line reliable, particularly against oceanic disturbances due to surface waves, internal waves, oceanic currents, and perturbations due to fish, mammals and other ocean life. A supervised deep learner may also be used to quantify patterns in the background disturbance based on which an optimal network in one embodiment.

When the AUVs are not operational, they are standing still on the deck station in one embodiment. The latter may be installed underwater near the surface. When one AUV has a system failure and ends up lost, it automatically goes back to the deck station.

The system can be used to stream a video from one or multiple robots to a control station located at the surface (e.g., marine structure inspections, search and rescue, environmental surveys, geophysical site inspection, intelligence). It can also be used to provide a direct feedback between one or multiple robots to a control station at the surface (e.g., marine structure operation and maintenance, and mine counter measurers).

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a schematic diagram showing a swarm of super-agile Autonomous Underwater Vehicles (AUVs) between a submarine and a ship according to one embodiment of the technology.

FIG. 2 is a schematic diagram showing data communication between two super-agile AUVs alone or within a swarm of AUV's.

FIG. 3 is a schematic diagram of an AUV with double gimbal control; moment gyro attitude stabilization according to one embodiment of the technology.

FIG. 4 is a schematic diagram of networks of coordinated AUV's forming a principal communication relay path. The AUVs on the principal path are considered leaders, and the connected AUVs in the localized networks outside of the principal path are followers.

FIG. 5 is a schematic diagram of an alternative swarm with AUV's with cameras or other sensors and other AUV's serving only as transmission relays.

FIG. 6 is a schematic diagram of a communications link between two points showing the principal path of optical transmissions between AUV's accounting for environmental disturbances such as ocean current encountered by AUV's in the swarm.

### DETAILED DESCRIPTION

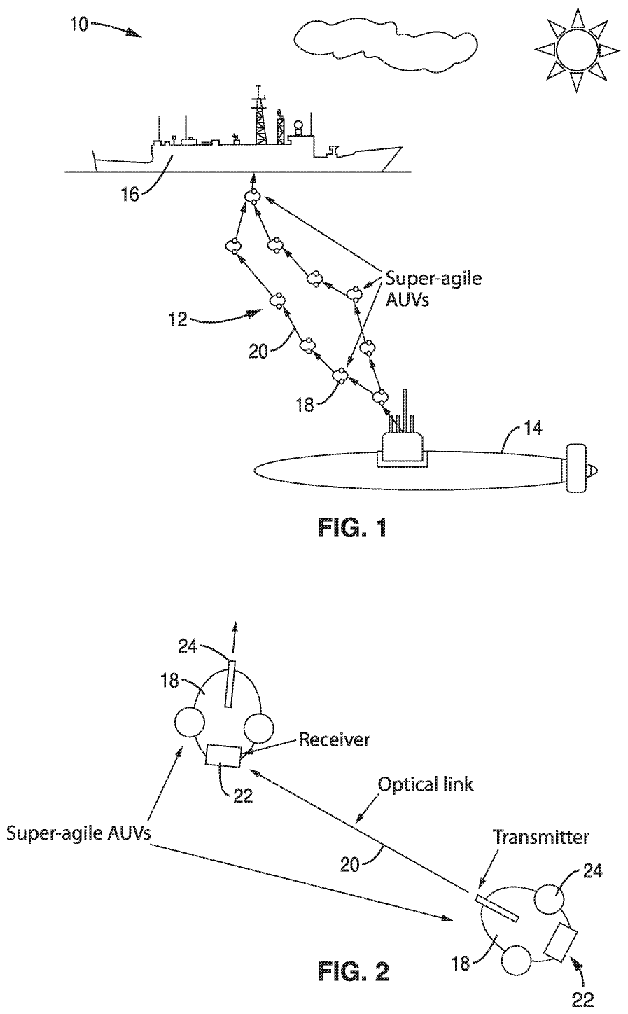

Referring more specifically to the drawings, for illustrative purposes, embodiments of apparatus, system and methods for optical communications systems using a coordinated swarm of autonomous under water vehicles equipped with laser transmitters and receivers are generally shown. Several embodiments of the technology are described generally in FIG. 1 to FIG. 6 to illustrate the characteristics and functionality of the devices, methods and systems. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1, one embodiment of an underwater optical communications system 10 between underwater and surface sources with a swarm 12 of a coordinated AUV's is shown schematically. For simplicity, the system of FIG. 1 depicts communications in only one direction from a submarine 14 to a surface ship 16. However, optical communications typically go in both directions. In this illustration, an optical signal from the submarine 14 is received by one or more AUV's 18 members of the swarm 12. The transmission of the high bandwidth optical signal 20 can be redundant and sent to more than one AUV 18 in the swarm 12 or signals can be sent in parts or packets between available members and finally assembled at the surface. The swarm 12 can be used to relay an optical signal 20 between two points at any distance or area as determined by the selected number and positioning of AUV members 18 of the swarm 12. Each vehicle 18 is preferably equipped with multiple attitude stabilization systems to reach the required pointing and tracking accuracy for optical communication. Accordingly, high-bandwidth underwater wireless communication can be achieved over long-distances or areas using a swarm of AUVs relaying multiple optical signals 20.

The ship 16 preferably has a control station including a controller and one or more fixed optical transmitters and receivers linked to a monitoring and surveillance system to monitor the swarm as well as a deck station including a support structure and parking area for the AUVs. The AUV's are parked in the deck station when the AUVs are not operational. The AUV's may automatically return to the deck station when it has a system failure and ends up lost in this embodiment.

As shown also in FIG. 2, the AUV's 18 are positioned at less than the maximum range of the laser of the nearest member. Each AUV preferably has a receiver 22 capable of receiving an optical signal 20, amplifying the signal and transmitting the amplified signal with laser transmitter 24 to one or more associated AUV's in the swarm that is at a position above, below or horizontal from the sender AUV.

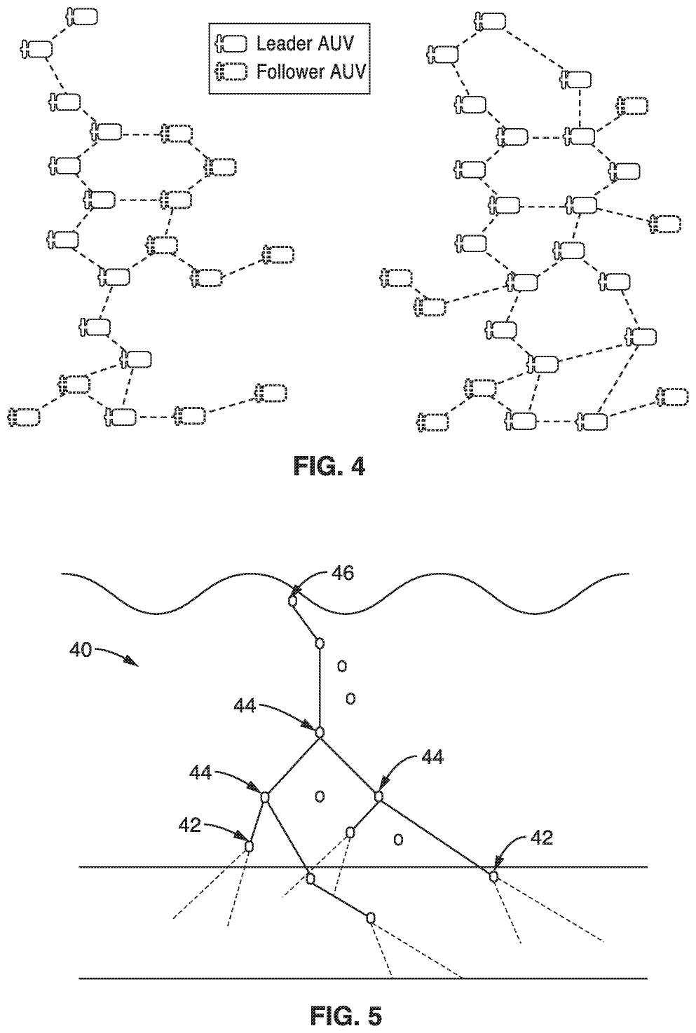

Each vehicle 18 must remain at a distance lower than the optical communication system range from each other while fighting against environmental disturbances such as ocean current. The swarm 12 is preferably composed of units relaying the signal and of redundant units which are ready to relay the signal in case one of the units is taken out of range, fails or has low battery as illustrated generally in FIG. 4.

In addition, many underwater activities require a communication in a range above 100 meters or take place in turbid water where the optical range can decrease to 10 meters. The system can be adapted to such conditions or circumstances by the number and spatial configuration of the swarm of AUVs relaying the optical signal between two points. The number of vehicles in the swarm can thus be adjusted to establish the communication in any water conditions and for any distance.

Each vehicle 18 is also preferably equipped with multiple attitude stabilization systems to reach the required pointing and tracking accuracy for optical communication. The main practical challenge in implementing the optical data communication with laser in water is the pointing accuracy and stability of the laser beam, as well as the beam divergence. In order to precisely steer a duplex laser beam between the transmitter (i.e. laser diode) and receiver (i.e. photodiode), an AUV 18 configuration with a three-layer architecture of attitude stabilization and control system is preferred. The first layer of the architecture is responsible for stabilizing the orientation of the main platform of the AUV by isolating it from any motion or rotation due to external sources such as random ocean currents. The second layer mechanically isolates the optical data communication system from the body of the AUV such that its orientation and pointing angle can be independently (and quickly) changed regardless of the vehicle's attitude. Finally, the third layer provides a very fine steering control and stabilization of the optical data beam.

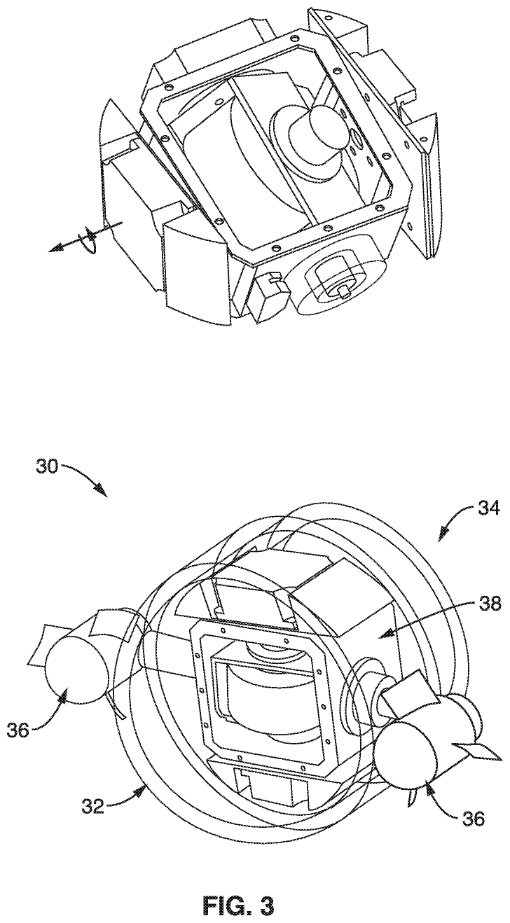

Referring also to FIG. 3, the preferred configuration of the AUV 30 has a cylindrical or spherical body with a transmitter system 32 and a receiver system 34. The body of the AUV also has preferably two or four positioning motors and propellers 36 to roughly locate and maintain the position of the AUV 30 at a coordinated location with respect to at least one other AUV's in the swarm. A Double Gimbal Control Moment Gyro (DGCMG) system 38 is used for attitude stabilization and control of the main platform where the laser data communication module along with the rest of the components (such as sensors, controllers, batteries, etc.) are mounted. In one embodiment, the laser platform is supported by a ball and plate balancing linkage. Location control over the laser beam is with a gimbal-less dual axis MEMS mirror in another embodiment.

The behavior of the swarm 12 is also important as it will determine the robustness and the autonomy of the overall communication link. In order to communicate, the AUVs construct a network where only AUV pairs within the maximum communication range of each other can talk to each other. Since the range of the AUV is much smaller than the distance between seabed to the ocean surface, a signal must hop through a set of AUVs. Therefore, sustaining the connectivity of the network against environmental disturbances and possible failure of some AUVs is a consideration.

As shown in the left swarm network of FIG. 4, the AUVs on the principal path are leaders (solid), and the connected AUVs in the localized networks are followers (dashed). The network may have only one principal path, or it may be configured to have an extra principal path to make the communication line more resistant to destruction of edges between the AUVs as illustrated in the right network of FIG. 4.

The AUVs constructing the principal or shortest path are called leaders and the other AUVs are the followers. Since the swarm network topology evolves over time, the principal path and its engaged AUVs may change. An AUV's role in a network may alternate between a leader and a follower depending on whether the AUV is part of the principal path or has dropped out. The role of the leader is to establish the communication line. The followers are redundancies that help the leaders to sustain the communication line.

The followers may also spread around the principal path in order to obtain environmental data and help with predicting the upcoming disturbances and flow regimes. The AUV's can also establish a secondary communication line with the help of the leaders in case the principal path is disconnected, the secondary path continues the communication. This will give enough time for the network to reconfigure by rebuilding the broken links or establishing new links and will increase the resilience of the communication line against the environmental disturbances.

The possibility of network rearrangement and self-organization of the swarm increases the adaptability of the network to its environment, and, by resisting communication disconnection, the operation efficiency of the network is increased.

The determination of the principal path and election of leader AUVs occurs at predetermined time intervals in one embodiment. After each inspection, the primary communication architecture of the swarm is solidified, and the followers are determined by the list of nearest neighbors of primary AUVs in the swarm network.

In one embodiment, the primary and secondary swarm network design has an absolute position of each AUV in the network. In an alternative embodiment, the absolute position of the leaders and the coordinates of the followers are determined relative to leaders' positions and establish localized communication between a leader and its connected followers without increasing the traffic along the principal path.

A reliable network structure should be resilient to environmental disturbances to sustain its connectivity and thus, preserve the communicability among the swarm of AUVs. The swarm of AUVs should avoid collisions between themselves or with obstacles and the network should have the possibility of disconnection and reconnection of an AUV with the swarm upon maneuvering and circumventing the obstacles. However, the design of adaptive and reliable network dynamics with reconfiguration capabilities in response to environmental conditions is a challenging task. Ad hoc network topologies like those shown in FIG. 4 are preferred to establish dynamic communication lines that are resistant to strong ocean disturbances at different ocean depths.

The members of the swarm can also have in addition to the communications relay function between AUV's. As shown in FIG. 5, some AUV members of the swarm 40 have cameras or other sensors that can provide a stream of data from each AUV 42 through the connected network for storage and evaluation. In this embodiment, the 42 are optically connected to node AUV's 44 that have a receiving and transmitting function that can surface vehicle, recorder or radio or satellite transmitter 46. In the configuration of FIG. 5 the members of the swarm are diversified and may have both sensing and communication functions. Control functions may also be directed through the network to individual AUV's as well as groups of AUV's.

The technology described herein may be better understood with reference to the accompanying examples, which are intended for purposes of illustration only and should not be construed as in any sense limiting the scope of the technology described herein as defined in the claims appended hereto.

### EXAMPLE 1

To demonstrate the functionality of the system and methods, two submarine models were modified and controlled to illustrate the relay an optical signal underwater between two points using a swarm of AUVs in a tank.

The swarm was composed of two modified submarine models equipped with mirrors to reflect the light beam emitted from a laser pointer at the bottom of the tank to a target close to the surface. A laser pointer was used whose intensity is not modulated. It was also assumed that the position of the vehicles in the swarm was known. Position will typically be computed by a high-level Model Predictive Controller.

The submarine model used was an off-the-shelf toy submarine for the main body and for the propulsion system. Each 40 cm long submarine had three propellers, with a diameter of 2 cm, each controlling heave, surge, and yaw respectively and a 6V motor's power supply. A sealed enclosure was attached to the submarine's top bow to protect the electronic boards from water entry. To offset the enclosure's buoyancy, weights and air-filled syringes were attached to different areas on the submarine to ensure neutral buoyancy and level attitude. Finally, a mirror was attached to the front of each submarine. The submarine's motors and their power supply were connected to the electronic boards through four barbed tube fittings. A fifth fitting was used for the receiver's antenna. This design allowed a proper sealing at the connection between the box and the tubes. As the enclosure was only water-resistant, duct seal and duct tape were added around its lip to make it waterproof.

This demonstration focused on low-level control of the submarine models which is the main challenge to relay of the optical signal. It is indeed necessary that both vehicles keep a stable position, have a high disturbance rejection and a low noise sensitivity.

The wave tank was 45 cm wide and 2 meters deep constraining the experiment to two dimensions. The control of the submarine was therefore focused on the surge and heave motion. Pitch motion (rotation in the xz-plane) of the submarine models was naturally stable and yaw control was however implemented to keep the submarine in the xz-plane.

Therefore, a tailored controller needed to be implemented which required the installation of a micro-processor on the submarine models with a proper sealing. Finally, the position of the vehicles also needed to be measured in real-time to close the loop. To know the positions of the submarines, an image processing technique was developed that required the setup of a RF communication link at 315 Mhz between the computers processing the camera's videos and the units.

Specially designed printed circuit boards were produced for the submarine to include the functions of motor control via a motor driver, communications and absolute orientation via sensors. An Arduino Mega 2560 board with the Atmel ATmega2560 micro-controller chip was used for the main control functions of the submarine. A motor driver board, with two Toshiba TB6612FNG Dual H-Bridge motor drivers and an Adafruit 9-DOF IMU Breakout board with Absolute Orientation Sensor BNO055 were also used. The IMU board could output a variety of sensor data. This sensor data included absolute orientation in both three-axis data and four-point quaternion output, a three-axis angular velocity vector, a three-axis acceleration vector, a three-axis magnetic field strength vector, a three-axis linear acceleration vector, a three-axis gravity vector, and ambient temperature.

To control two submarines using the same frequency modules, different command intervals were specified for each submarine to assure that the messages were being sent to the correct submarine. Message packages of three digits, the minimum number of digits per command with four allowable intervals, were sent through the transmitters. The range of each interval was 199 or 200 where the median of each interval corresponded to an OFF command. The RF wireless transmitter sent motor commands to each submarine consisting of two motors each: surge and heave.

The control system was developed with controllers implemented to control the surge and heave positions. They use the position of the LEDs computed by image processing as inputs and return a motor command that has been set between 0 and 100 to reduce the number of bytes sent through RF wireless communication. The commands are then converted by the Arduino board on the submarine model to PWM signals that drive the heave and surge motor rotational speeds. To keep the heading of the submarine stable, a proportional control in yaw has been implemented on the Arduino. It uses the yaw angle measured by the IMU as input and directly computes the PWM signal sent to the yaw motor.

To evaluate the optical signal transmission with multiple AUV's, two identical systems were use as described running on two independent computers. Each submarine's position was captured by a camera connected to a computer. The computer then sent a command to the submarine through a transmitter taped on the water tank wall.

A class 3R laser has been used with a wavelength of 532 nm and a power output of less than 5 mW. The laser was housed in a waterproof acrylic sealed case that permitted the emission of the light beam and positioned at the bottom of the water tank. The light beam from the laser was first reflected by the lower submarine's mirror, then by the upper submarine's mirror and finally directed to the target just below the surface. The experiment was repeated several times and the optical signal transmission could be established every time.

Once the laser was turned on underwater, the lower submarine was controlled to its reference position where the light beam was reflected on its mirror. The upper submarine was then controlled to its reference position turning on the optical transmission from the bottom of the tank to the surface. To test the control system, a stick was used to disturb the submarines. They were able to go back to their position in a short amount of time setting back up the optical transmission to the surface.

These tests demonstrate qualitatively that laser light could be manipulated in a water medium so high bandwidth wireless communication were feasible. The test also showed that it is possible to precisely steer a laser beam emitted from the bottom of a water tank to the surface relayed through independently controlled submersibles.

### EXAMPLE 2

To further demonstrate the operational principles of the apparatus and methods, a convex optimization program was developed to maximize the communication link autonomy while assuring its robustness. To establish the communication link, the distance between each unit needs to be lower than the optical system range despite environmental disturbances such as ocean current. This nonlinear optimization problem is formulated considering AUVs as point masses and is then transformed to a Second-Order Cone Problem (SOCP), which can be efficiently solved with Yalmip in Matlab. The performance of the method was then compared to a direct approach, where the reference position of the vehicles is fixed. It was shown with two case studies, on two case studies that the autonomy of the swarm and thus the lifetime of the communication link is increased by more than 10% compared to a direct approach where the reference position of the vehicles is fixed.

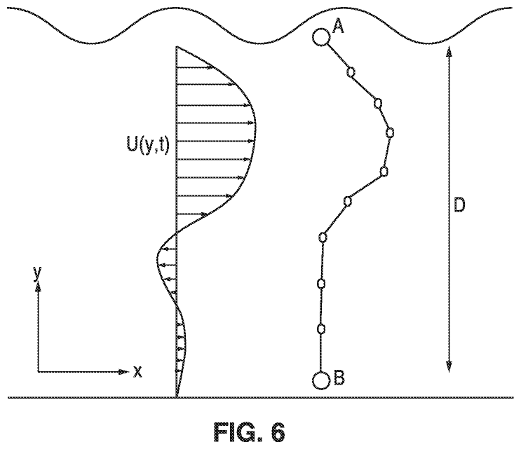

As shown in FIG. 6, a swarm of N AUVs is needed to establish a wireless communication link between a point A at the surface and a point B located at a distance D under the water free-surface. Each AUV is assumed to be equipped with an optical communication system with a range dₒₚₜ and the AUV must fight against a time-varying non-homogeneous current with speed U(y; t) as illustrated in FIG. 6.

Three assumptions were made to carry out the optimization: (i) N>D/dopt such that there is enough AUVs to relay an optical link from A to B; (ii) Vₘₐₓ>U(y; t) ∀y; t where Vₘₐₓ is the maximum speed of the AUVs, such that AUVs are never washed out downstream; and (iii) Ocean current speed is assumed to be known or predictable.

The main objective of the optimization is to minimize the power consumption of the AUVs in order to keep the optical link functional as long as possible. A direct approach would be to enforce the reference position of the AUVs at a fixed location such that the distance between two units is less than the optical communication system range. In this case, the vehicles will constantly adjust their thrust to the environmental conditions which is obviously sub-optimal. This constraint was relaxed by developing a convex optimization program that allows one to maximize the duration of the communication link.

The nonlinear optimization problem was represented as:

$${X}_{1} ( k ) , … , {{X}_{N}}^{min} ( k ) , {U}_{1} ( k ) , … , {U}_{N} ( k ) {{\sum }_{k = 1}}^{{N}_{T}} {{\sum }_{k = 1}}^{N} {P}_{i} ( k ) ,$$

subject to the state space model:

Xᵢ₊₁(k+1)=f(Xᵢ(k), Uᵢ(k)), ∀k ∈ {1, . . . , N_{T}}, and

communication constraints; where Xᵢ(k), (respectively Uᵢ(k)) is a vector representing the states (resp. inputs) of the i-th AUV as a function of the discretized time k, Pᵢ(k) is the power consumed by the i-th AUV at each time k. The AUV's dynamics is represented by its state space model. Finally, the communication constraints represent the requirements imposed on the AUV to keep the communication link activated. We will consider two different constraints, the direct approach that imposes the AUVs to remain in a box around a predefined location and the relaxed constraint that will let the AUV free of its motion as long as the distance between two units remains below the optical system communication range.

The AUV was modelled as a point mass in the 2D xy-plane. Its body has a spheroid shape with semi-axis lengths a and b of respectively 15 cm and 10 cm. It has 4 propellers with a diameter of 55 mm: 2 in the x-direction and 2 in the y-direction. Adding the rotational speed limitation of the propeller and initial conditions the original nonlinear problem was transformed into a Second-Order Cone Problem which could be efficiently solved with an optimization toolbox. The convex optimization program can be used to maximize the lifetime of a wireless communication link established through a swarm of AUVs relaying an optical signal.

In a first case study, the communications link experiencing time-varying shear currents was simulated. In this study, a communications link is established between a support vessel at the surface and a heavy work class Remotely Operated Vehicle (ROV) located at the sea bottom (e.g. point A and B on FIG. 6) at a site with a depth D=420 m. The time-varying current encountered on site was expressed as:

$$U ( y , t ) = {( \frac{D + y}{D} )}^{α} ( {U}_{0} + {U}_{1} sin ( \frac{2 π}{T} ) t ) ,$$

where U₀ is the steady component of the current equal to 1 m/s, U1 is the sinusoidal component equal to 0.5 m/s, T is the period equal to 1 minute, a is the shear coefficient equal to 0.2. The current velocity profiles at different times over one period was simulated. A large turbidity of the ocean value was assumed limiting the optical communication system range to d=40 m and thus requiring the use of N=10 vehicles. The sampling time TS was set to 4 second. The solution of the optimization program described above was compared to a direct approach where the box constraints are defined by tolerances of Dₓ=±0:1 m and D_{y}=±0:1 m around each AUV's initial position.

With the optimized method, the swarm behavior can be split in a transient phase and a steady-state phase. AUVs first use their propellers to modify the swarm topology into an optimized shape. Then, the swarm could oscillate as a function of time at the same frequency as the current and with the same optimal pattern.

At the beginning of the simulation, the propellers rotate at higher speed corresponding to the initial transient phase where the swarm has to make an additional effort to reach its optimal topology. After one or two periods, depending on the AUV, a steady-state is reached, and the rotational speed becomes constant except for the AUVs at the swarm extremities which need to slightly adjust their rotational speed because they are communicating with a fixed point. The upper AUV obviously requires higher thrust oscillations to maintain the communication open with the support vessel as current speed is assumed to be higher near the surface.

Compared to the direct approach, the optimized approach smoothed the rotational speed over time which simplifies the design of the low-level control of the propellers. The improvement reached with this optimized method was quantified by comparing the energy consumed in steady state by the AUVs over 1 hour with the optimized method and with the direct approach. Results showed a reduction between 12% and 15% in the AUVs power consumption.

To gain some insight in the optimized swarm behavior, AUV which is not at the swarm extremities was considered. The optimization program set the propeller rotational speeds to a constant value such that the corresponding thrust is exactly the opposite of the drag force generated by the mean ocean current speed at a given depth. As a result, the total force driving the AUV's dynamics is an oscillatory force with zero mean.

Secondly, the optimization program shifts the phase of the AUV's motion by p compared to the current's phase. Therefore, the AUV moves upstream when the current velocity is higher than its mean value and vice versa. This dynamic generates sustained oscillations using the time-varying component of the current drag force as a restoring force. The AUVs near the swarm extremities tend towards this behavior as their rotational speed oscillation is reduced but the communication constraint with the fixed points A or B prevent them from reaching constant rotational speed. This swarm dynamics nonetheless allows the reduction of the inefficient succession of acceleration and deceleration inherent to the direct approach which eventually leads to a decrease in overall power consumption.

In a second case study, the circumstance of time varying currents with reverse flow was evaluated. For deeper sites, the swarm of AUVs might experience an ocean current with a reverse flow caused by the variability of water temperature or of water density. To demonstrate the performance of the optimized method in such conditions, a site with a depth D=2100 m with a forward and reverse current velocity profile with water depth was considered. Such sites are far from the coast and generally have low turbidity increasing the optical communication range to 100 m and limiting the required number of vehicles to N=20.

The temporal evolution of the swarm with the optimized method is analogous to the previous case with a transient and a steady-state phases. The optimal topology was adjusted to the given current velocity profile and was similar to a standing wave with nodes where the current velocity is minimal and the antinodes where current velocity is maximal. In reverse flow, propellers rotate in an opposite direction to balance the drag force and the optimization program adapts the phase of the AUVs motion to the change of direction of the current. The optimized program approach allowed a reduction in power consumption to be reached of the same order of magnitude as for the previous shear current case.

Large oscillations in the observed rotational speed of each of the propellers with the optimized method indicated that the communication constraints become active limiting the ability of the optimization program to smooth the rotational speed. A non-uniform swarm where the density of AUVs is higher around these locations would give more slack to the AUVs, removing their need to change their propellers rotational speed to keep the communication link active and thus reducing their power consumption. These criteria can be used to define the optimal arrangement of AUVs along the depth by iteratively adding units at these locations until all AUVs have constant rotational speed.

Accordingly, the results of the optimization program can maximize the lifetime of a wireless communication link established through a swarm of AUVs relaying an optical signal. The swarm behavior can be split into a transient phase, where the swarm is transitioning to an optimized topology, and a steady-state phase, where the swarm is oscillating at the current's frequency following the same pattern. This sustained oscillation can be obtained by setting the AUVs propellers rotational speed to a constant value such that their thrust is exactly the opposite of the drag force generated by the mean current velocity. The two case studies showed that a 10% to 15% reduction in the AUVs power consumption can be achieved. The case studies also showed that some AUVs may have to change their rotational speed to respect the communication constraint, but this can be improved by using a non-uniform distribution of AUVs.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

Furthermore, these computer program instructions, such as embodied in computer-readable program code, may also be stored in one or more computer-readable memory or memory devices that can direct a computer processor or other programmable processing apparatus to function in a particular manner, such that the instructions stored in the computer-readable memory or memory devices produce an article of manufacture including instruction means which implement the function specified in the block(s) of the flowchart(s). The computer program instructions may also be executed by a computer processor or other programmable processing apparatus to cause a series of operational steps to be performed on the computer processor or other programmable processing apparatus to produce a computer-implemented process such that the instructions which execute on the computer processor or other programmable processing apparatus provide steps for implementing the functions specified in the block(s) of the flowchart(s), procedure(s) algorithm(s), step(s), operation(s), formula(e), or computational depiction(s).

It will further be appreciated that the terms “programming” or “program executable” as used herein refer to one or more instructions that can be executed by one or more computer processors to perform one or more functions as described herein. The instructions can be embodied in software, in firmware, or in a combination of software and firmware. The instructions can be stored local to the device in non-transitory media or may be stored remotely such as on a server, or all or a portion of the instructions can be stored locally and remotely. Instructions stored remotely can be downloaded (pushed) to the device by user initiation, or automatically based on one or more factors.

It will further be appreciated that as used herein, that the terms processor, hardware processor, computer processor, central processing unit (CPU), and computer are used synonymously to denote a device capable of executing the instructions and communicating with input/output interfaces and/or peripheral devices, and that the terms processor, hardware processor, computer processor, CPU, and computer are intended to encompass single or multiple devices, single core and multicore devices, and variations thereof.

From the description herein, it will be appreciated that that the present disclosure encompasses multiple embodiments which include, but are not limited to, the following:

1. A system for underwater optical communications, the system comprising: (a) a control station with a system controller and at least one optical signal receiver; and (b) a group of autonomous underwater vehicles with an optical receiver and optical transmitter and vehicle controller, the vehicles spaced apart at distances less than the optical range of the optical transmitter of each vehicle; (c) wherein optical signals from a source are relayed to the system controller through optical signal transmissions from one vehicle to another in the group of vehicles to the control station optical signal receiver.

2. The system of any preceding or following embodiment, the control station further comprising: at least one optical signal transmitter controlled by the system controller; wherein control signals can be transmitted to one or more vehicles in the group of optically connected autonomous underwater vehicles.

3. The system of any preceding or following embodiment, the autonomous underwater vehicles further comprising: an attitude control system with a double gimbal control moment gyro to maintain position and attitude to preserve a communications link regardless of motion or rotation of the vehicles.

4. The system of any preceding or following embodiment, the autonomous underwater vehicles further comprising one or more position sensors.

5. The system of any preceding or following embodiment, the autonomous underwater vehicles further comprising a camera configured to stream a video from one or multiple AUV's to a surface-based control station.

6. The system of any preceding or following embodiment, the group of autonomous underwater vehicles further comprises: autonomous underwater vehicles with sensors that are not part of a direct optical communications pathway with the control station.

7. A system for underwater optical communications, comprising: (a) an optical command and control system with controller and one or more optical transmitters and receivers; and (b) a plurality of Autonomous Underwater Vehicles (AUVs), each the AUV comprising: (i) a vehicle body with a non-inertial actuator and a plurality of exterior thrusters configured to accurately control orientation and position of the AUV in three-dimensional space; (ii) at least one optical receiver configured to receive optical signals; (iii) at least one optical signal transmitter; and (iv) an AUV controller, the controller configured to receive and process optical transmissions from the command and control system, control vehicle attitude and position and transmit optical signals to the command and control system.

8. The system of any preceding or following embodiment, the AUV further comprising: a position sensor, the AUV controller configured to process data provided by the position sensor and to provide inputs to the actuator and thrusters in order to align the optical transmitter of the AUV with a receiver of another AUV or with a receiver of the command and control system.

9. The system of any preceding or following embodiment, the AUV further comprising a camera, wherein camera data can be transferred from one or multiple AUV's to the command and control system through optical signals.

10. The system of any preceding or following embodiment, wherein the actuator of the AUV is an actuator selected from the group of actuators consisting of a momentum wheel, a reaction wheel, a single gimbal control moment gyro, and a double gimbal control moment gyro.

11. The system of any preceding or following embodiment, the AUV further comprising: an optical signal targeting system controlled by the AUV controller, wherein a location of a laser optical signal from the optical signal transmitter can be targeted by the AUV controller.

12. The system of any preceding or following embodiment, further comprising: a control station, the control station housing the command and control system, and one or more fixed optical receivers linked to a monitoring and surveillance system; and a deck station, the deck station having an underwater support structure and a parking area for the AUVs.

13. The system of any preceding or following embodiment, wherein when one AUV has a system failure and ends up lost, it automatically returns to the deck station.

14. The system of any preceding or following embodiment, wherein the AUV controller comprises: (a) a processor; and (b) a non-transitory memory storing instructions executable by the processor; (c) wherein the instructions, when executed by the processor, perform steps comprising: (i) receiving an optical signal with the optical signal receiver; (ii) identifying a target; (iii) orienting a direction of an optical signal transmitter beam towards the identified target with the attitude stabilization system or thrusters; (iv) relaying the received optical signal to the target; and (v) maintaining the optical signal transmission beam on the target for a period of time.

15. A method for underwater optical communications, the method comprising: (a) providing a swarm of a plurality of autonomous underwater vehicles, each vehicle comprising a mechanical system, a controller, an optical receiver, an optical transmitter, and a position sensor; (b) forming an optical link between one or more autonomous underwater vehicle; and (c) relaying a received optical signal to at least one other autonomous underwater vehicles in the swarm.

16. The method of any preceding or following embodiment, further comprising: sensing the position and orientation of the autonomous underwater vehicle; targeting an optical receiver of the closest autonomous underwater vehicle neighbor; and controlling the mechanical system to accurately control orientation and position of the AUV and the optical transmitter beam to strike the target.

17. The method of any preceding or following embodiment, further comprising: maintaining the optical signal transmission beam on the target for a period of time.

18. The method of any preceding or following embodiment, further comprising: providing a command and control system with system controller and one or more optical transmitters and optical receivers; sending command optical signals to the optical receiver and controller of at least one autonomous underwater vehicle in the swarm; controlling activity of the mechanical system and position of the vehicle with the command signal from the command and control system; and controlling the optical transmitter of the vehicle with the command signal from the command and control system.

19. The method of any preceding or following embodiment, further comprising: amplifying a received optical signal before transmission to a second vehicle or command and control system.

20. The method of any preceding or following embodiment, further comprising: relaying a received optical signal to more than one autonomous underwater vehicle.

21. The method of any preceding or following embodiment, further comprising: providing each autonomous underwater vehicle in the swarm with a camera operably connected to the controller; and using a camera image to target an optical receiver and to position and orient a beam from the optical transmitter with the mechanical system.

22. A system for long-distance and/or wide-area underwater free space optical communication, comprising: a plurality of Super-Agile Autonomous Underwater Vehicles (AUVs); each the AUV comprising a mechanical system, a controller, a receiver, a transmitter, and a position sensor; the mechanical system configured to accurately control orientation and position of the AUV; the controller configured to process data provided by the position sensor and provide inputs to the mechanical system in order to align the transmitter of the AUV to the of another AUV; wherein the transmitter and receiver are components of a Free Space Optical system providing for high bandwidth optical communication; the position sensor configured to provide information on surroundings of the AUV including the presence of other AUVs; wherein high stability and agility of the AUV allows to maintain a correct alignment between the receiver and the transmitter of two different AUVs to keep data communication operational; wherein in the case that communication is lost, the AUV uses data provided by the position sensor to restore the connection; wherein the plurality of AUVs allow communication over a long-distance between two points and over a wide area.

23. The system of any preceding or following embodiment, further comprising: a control station; the control station including one or more fixed receivers linked to a monitoring and surveillance system; and a deck station, the deck station including a support structure and parking area for the AUVs.

24. The system of any preceding or following embodiment, wherein when the AUVs are not operational, they are parked on the deck station.

25. The system of any preceding or following embodiment, wherein the deck station is installed underwater near the surface.

26. The system of any preceding or following embodiment, wherein when one AUV has a system failure and ends up lost, it automatically returns to the deck station.

27. The system of any preceding or following embodiment, wherein the system is configured to stream a video from one or multiple robots to a surface-based control station.

28. A method for long-distance and/or wide-area underwater free space optical communication, comprising: providing a plurality of Super-Agile Autonomous Underwater Vehicles (AUVs); each the AUV comprising a mechanical system, a controller, a receiver, a transmitter, and a position sensor; the mechanical system configured to accurately control orientation and position of the AUV; the controller configured to process data provided by the position sensor and provide inputs to the mechanical system in order to align the transmitter of the AUV to the of another AUV; wherein the transmitter and receiver are components of a Free Space Optical system providing for high bandwidth optical communication; the position sensor configured to provide information on surroundings of the AUV including the presence of other AUVs; wherein high stability and agility of the AUV allows to maintain a correct alignment between the receiver and the transmitter of two different AUVs to keep data communication operational; wherein in the case that communication is lost, the AUV uses data provided by the position sensor to restore the connection; wherein the plurality of AUVs allow communication over a long-distance between two points and over a wide area.

29. The method of any preceding or following embodiment, further comprising: providing a control station; the control station including one or more fixed receivers linked to a monitoring and surveillance system; and providing a deck station, the deck station including a support structure and parking area for the AUVs.

30. The method of any preceding or following embodiment, further comprising parking AUVs on the deck station when the AUVs are not operational.

31. The method of any preceding or following embodiment, wherein the deck station is installed underwater near the surface.

32. The method of any preceding or following embodiment, further comprising automatically returning an AUV to the deck station when it has a system failure and ends up lost.

33. The method of any preceding or following embodiment, further comprising streaming video from one or multiple robots to a surface-based control station.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A system for underwater optical communications, the system comprising:
(a) a control station with a system controller and at least one optical signal receiver; and
(b) a group of autonomous underwater vehicles with an optical receiver and optical transmitter and vehicle controller, said vehicles spaced apart at distances less than the optical range of the optical transmitter of each vehicle;
(c) wherein optical signals from a source are relayed to the system controller through optical signal transmissions from one vehicle to another in the group of vehicles to the control station optical signal receiver.

2. The system of claim 1, said control station further comprising:
at least one optical signal transmitter controlled by the system controller;
wherein control signals can be transmitted to one or more vehicles in the group of optically connected autonomous underwater vehicles.

3. The system of claim 1, said autonomous underwater vehicles further comprising:
an attitude control system with a double gimbal control moment gyro to maintain position and attitude to preserve a communications link regardless of motion or rotation of the vehicles.

4. The system of claim 1, said autonomous underwater vehicles further comprising one or more position sensors.

5. The system of claim 1, said autonomous underwater vehicles further comprising a camera configured to stream a video from one or multiple AUV's to a surface-based control station.

6. The system of claim 1, said group of autonomous underwater vehicles further comprises:
autonomous underwater vehicles with sensors that are not part of a direct optical communications pathway with the control station.

7. A system for underwater optical communications, comprising:
(a) an optical command and control system with controller and one or more optical transmitters and receivers; and
(b) a plurality of Autonomous Underwater Vehicles (AUVs), each said AUV comprising:
(i) a vehicle body with a non-inertial actuator and a plurality of exterior thrusters configured to accurately control orientation and position of the AUV in three-dimensional space;
(ii) at least one optical receiver configured to receive optical signals;
(iii) at least one optical signal transmitter; and
(iv) an AUV controller, said controller configured to receive and process optical transmissions from the command and control system, control vehicle attitude and position and transmit optical signals to the command and control system.

8. The system of claim 7, said AUV further comprising:
a position sensor, said AUV controller configured to process data provided by the position sensor and to provide inputs to the actuator and thrusters in order to align the optical transmitter of the AUV with a receiver of another AUV or with a receiver of the command and control system.

9. The system of claim 7, said AUV further comprising a camera, wherein camera data can be transferred from one or multiple AUV's to the command and control system through optical signals.

10. The system of claim 7, wherein said actuator of the AUV is an actuator selected from the group of actuators consisting of a momentum wheel, a reaction wheel, a single gimbal control moment gyro, and a double gimbal control moment gyro.

11. The system of claim 7, said AUV further comprising:
an optical signal targeting system controlled by said AUV controller,
wherein a location of a laser optical signal from said optical signal transmitter can be targeted by said AUV controller.

12. The system of claim 7, further comprising:
a control station, said control station housing the command and control system, and one or more fixed optical receivers linked to a monitoring and surveillance system; and
a deck station, said deck station having an underwater support structure and a parking area for the AUVs.

13. The system of claim 12, wherein when one AUV has a system failure and ends up lost, it automatically returns to the deck station.

14. The system of claim 7, wherein the AUV controller comprises:
(a) a processor; and
(b) a non-transitory memory storing instructions executable by the processor;
(c) wherein said instructions, when executed by the processor, perform steps comprising:
(i) receiving an optical signal with the optical signal receiver;
(ii) identifying a target;
(iii) orienting a direction of an optical signal transmitter beam towards the identified target with the attitude stabilization system or thrusters;
(iv) relaying the received optical signal to the target; and
(v) maintaining the optical signal transmission beam on the target for a period of time.

15. A method for underwater optical communications, the method comprising:
(a) providing a swarm of a plurality of autonomous underwater vehicles, each vehicle comprising a mechanical system, a controller, an optical receiver, an optical transmitter, and a position sensor;
(b) forming an optical link between one or more autonomous underwater vehicle; and
(c) relaying a received optical signal to at least one other autonomous underwater vehicle in the swarm.

16. The method of claim 15, further comprising:
sensing the position and orientation of the autonomous underwater vehicle;
targeting an optical receiver of the closest autonomous underwater vehicle neighbor; and
controlling the mechanical system to accurately control orientation and position of the AUV and the optical transmitter beam to strike the target.

17. The method of claim 16, further comprising:
maintaining the optical signal transmission beam on the target for a period of time.

18. The method of claim 15, further comprising:
providing a command and control system with system controller and one or more optical transmitters and optical receivers;
sending command optical signals to the optical receiver and controller of at least one autonomous underwater vehicle in the swarm;
controlling activity of the mechanical system and position of the vehicle with the command signal from the command and control system; and
controlling the optical transmitter of the vehicle with the command signal from the command and control system.

19. The method of claim 15, further comprising:
amplifying a received optical signal before transmission to a second vehicle or command and control system.

20. The method of claim 15, further comprising:
relaying a received optical signal to more than one autonomous underwater vehicle.

21. The method of claim 15, further comprising:
providing each autonomous underwater vehicle in the swarm with a camera operably connected to the controller; and
using a camera image to target an optical receiver and to position and orient a beam from the optical transmitter with the mechanical system.
